(19) United States
(12) Patent Application Publication
(10) Pub. No.: US 2008/0275717 A1
(43) Pub. Date: Nov. 6, 2008

(54) DELIVERING VOCATIONAL REHABILITATION INFORMATION AND SERVICES

(76) Inventors: Mary Joan Willard, Mill Valley, CA (US); Joseph S. Bousquet, Brighton, MA (US); Peter A. O'Leary, Winthrop, MA (US)

Correspondence Address: GOODWIN PROCTER LLP;PATENT ADMINISTRATOR, EXCHANGE PLACE, BOSTON, MA, 02109-2881, US

(21) Appl. No.: 12/113,459

(22) Filed: May 1, 2008

Related U.S. Application Data
(60) Provisional application No. 60/927,106, filed on May 1, 2007.

(51) Int. Cl. G06Q 50/00

(52) U.S. Cl. 705/1

(57) ABSTRACT

The invention provides techniques for educating potential employees about job seeking and job maintenance resources. In one aspect, potential employees identified as receivers of government-provided benefits are automatically contacted about receiving such resources. The may be presented with menu of available employment and incentive services, and requests for such information may be fulfilled based on menu selections made by the potential employee.

### CROSS-REFERENCE TO RELATED APPLICATIONS

This application claims priority to and the benefits of U.S. provisional patent application Ser. No. 60/927,106, filed on May 1, 2007, the entire disclosure of which is incorporated herein by reference.

### TECHNICAL FIELD

The present invention is directed to methods and systems for matching individuals seeking employment with potential employers and, more specifically, for providing the employers and individuals receiving government benefits with information and assistance regarding employment, benefits and incentives related to both.

### BACKGROUND

Approximately 10 million Americans of working age currently receive federal disability benefits from the Social Security Administration. In any given year, approximately 9% of disabled individuals receiving Social Security benefits report some work earnings; however, the vast majority of these individuals do not earn enough to be fully self-sufficient. Only about ½ to 1% of individuals receiving Social Security benefits leave the benefit rolls each year due to a successful full return to work. Yet, in a 1998 poll conducted for the National Organization on Disability, 72% of adults with disabilities who were not employed reported that they would prefer to be employed. While those individuals receiving Social Security benefits are the largest single contingent of unemployed individuals with disabilities, hundreds of thousands of others qualify for vocational rehabilitation related services or benefits from state vocational rehabilitation agencies or insurance companies. These individuals also confront significant obstacles to becoming partially or fully self-supporting.

In an effort to increase the probability that disabled individuals will obtain either full-time or part-time jobs and, as a result, reduce financial burdens on federal and state governments, various changes to the work incentives offered under the Social Security Administration and Supplemental Security Income Disability Programs have been made over the past 25 years. While these policy changes have made minor adjustments to the system of incentives and the related rules and regulations, such changes have not had a significant impact.

In a report entitled “Trends in the Social Security and Supplemental Security Income Disability Programs” published in August of 2006 by the Social Security Administration's Office of Research, Evaluation, and Statistics, the authors describe several policy changes to work incentives over the past 25 years. They conclude that “[i]t does not appear that policy changes have resulted in any significant increases in successful returns to work.” Unfortunately, this report did not identify the source of the problem: ineffective incentives, ineffective vocational rehabilitation and employment support services, or ineffective methods for educating disabled recipients of Social Security benefits and/or employers about the incentives and support systems.

In an effort to assist individuals seeking employment and to promote other employment support activities, the federal and state governments offer a variety of services, typically through state-run vocational rehabilitation agencies, who typically offer assistance without charge to individuals with disabilities seeking employment. For examine, according to the Cornell Center for Policy Research, in 2002 the federal government spent approximately $226 billion to help working-age individuals with disabilities, while state agencies spent approximately $50 billion in federal-state programs targeted to help the same population. Examples of services offered include counseling and guidance, referrals and assistance to obtain services via other agencies, job search and placement assistance, vocational and other training services including full or partial college tuition, diagnosis and treatment of physical and mental impairments, transportation, on-the-job support, personal assistance services, occupational licenses, provision of tools and equipment, technical services for self-employment and technical accommodations for jobs. While the federal-state vocational rehabilitation agencies are the largest providers of such services, similar services are often available via insurance company rehabilitation programs, employment networks or nonprofit disability organizations.

Even though there is a wealth of support services available to assist disabled individuals seeking employment, many disabled individuals are either unaware of the variety of such services or the extent to which they can access these services free of charge. Also, those who are aware of such services are sometimes afraid to access them for fear that the government will use their interest in work as evidence they are now capable of returning to work and subsequently terminate their benefits.

Uncertainty as to the conditions under which members of this population can work while retaining full or partial benefits can be a major disincentive to exploring work. The rules and regulations pertaining to benefit terminations and work exploration can be complex, confusing and intimidating, especially to a layman. While federal and state government agencies have focused resources on providing vocational-related services to those expressing a need for them, very little effort is expended on communicating information about these resources to beneficiaries who have not initiated such a request. For example, in rolling out a major Social Security return to work support effort called “Ticket to Work” in 2001, the Social Security Administration sent every eligible beneficiary on the rolls a letter about this new program. Between 2001 and 2008 this Ticket to Work program has constituted the federal governments' premier effort at providing work support services to beneficiaries, but beneficiaries received only a single letter, and while Social Security can verify that a single letter was mailed, they do not know how many beneficiaries actually received that letter, let alone how many read it. Estimates that 50% of the addresses on file at the Social Security Administration do not bode well for such projects. And since the Social Security Administration moved to a system of direct depositing all disability checks to the bank account of the beneficiary, there is really no need to correct any incorrect addresses.

Beneficiary's lives change everyday. To prompt and support employment seeking and employment maintenance behavior, offers of assistance should be communicated to beneficiaries at periodic intervals. In addition, the information should be communicated in a user-friendly manner and should be clear so that beneficiaries fully understand the impact full or part-time work will have on their cash and medical benefits.

In addition to providing job seeking and support services to individuals, the federal government offers tax credits and other incentives to employers who hire people that receive some sort of government aid, such as disability payments. Unfortunately, most employers are unfamiliar with the availability of such incentives, and those employers who are aware of the incentives complain that the paperwork and procedures to obtain the tax credits are confusing, time-consuming and burdensome. Therefore, even though many employers would find the tax credits an inducement to hiring such individuals, the lack of knowledge concerning the incentives and the daunting paperwork required when they do learn of the incentives keeps the incentives from having much of an impact on actual hiring.

### SUMMARY OF THE INVENTION

The invention seeks to provide cost-effective methods for promoting and maintaining job seeking behavior of individuals currently receiving government benefits. These outreach methods complement more passive methods of information dissemination provided via direct mailings, web sites, toll-free numbers, group sessions, and one-on-one requests for meetings initiated by the potential employees. In one aspect, the invention provides a method to educate individuals (such as those receiving Social Security and/or other disability benefits) about various incentives and job seeking and job maintenance resources available to them. Specifically, the method includes receiving a list of potential employees that have been identified as receivers of government-provided benefits, automatically contacting the potential employees using a selection criteria (e.g., geographic location, skill set, level of interest, type of disability benefit received, impairment code, or the like), providing the potential employees with a menu of available employment related information pieces and services, receiving a request from a potential employee for information regarding one or more of the services and delivering the requested information electronically and/or in hardcopy.

The potential employees can be contacted via telephone (using PSTN and/or VOIP technology) and/or email, using, for example, auto-dialer or email blasting software. In some cases, contact is made multiple times (e.g., every three months, twice annually, etc.) In some embodiments, the services may include access to a counselor, such that the requested information can be delivered in person. In other implementations, the services may be delivered remotely using distance-learning methods. In some cases, follow-up contacts may be scheduled and initiated based on a contact algorithm that considers individuals' responses to previous contacts, the requested information, and other demographic characteristics of the individuals when scheduling the follow-up contacts.

In another aspect, the invention provides a method for matching qualified disabled individuals seeking employment with employers currently looking to hire new employees and/or contractors. The method includes the steps of receiving a list of potential employees identified as receivers of government-provided benefits, receiving a list of potential employers, matching potential employees to potential employers, automatically contacting the potential employees, and providing information to the potential employees regarding the potential employers.

Matching of the employees to employers can be based, for example, on geographical and/or other demographic characteristics, as well as specific skill sets. Potential employees may be contacted via telephone (using PSTN and/or VOIP technology), and in some cases using auto-dialer technology including outbound interactive voice response technology. Potential employees may also be contacted using email, using, for example, email blasting software. In certain implementations, information regarding potential employer incentives may be provided to the potential employers.

In another aspect, the invention provides a system for implementing the methods described above. Specifically, the system includes a data storage device, a matching module and a telephony subsystem. The data storage device is configured to store a list of potential employees receiving government-provided benefits, a list of benefits potentially available to the potential employees and a list of potential employers. The matching module is configured to compile a listing of potential benefits and potential employers for individuals based on characteristics of the potential employees and the potential employers. The telephony subsystem is configured to automatically contact the potential employees via telephone and present information from the compiled list to the potential employees.

### BRIEF DESCRIPTION OF THE DRAWINGS

The foregoing and other objects, aspects, features, and advantages of the invention will become more apparent and may be better understood by referring to the following description taken in conjunction with the accompanying drawings, which illustrate several embodiments of the invention.

FIG. 1 is a block diagram of a system for providing employment assistance in accordance with one embodiment of the invention.

FIG. 2 is a flow chart illustrating a method for providing employment assistance in accordance with one embodiment of the invention.

FIG. 3 is a flow chart illustrating a method for providing employment assistance in accordance with one embodiment of the invention.

### DESCRIPTION OF THE INVENTION

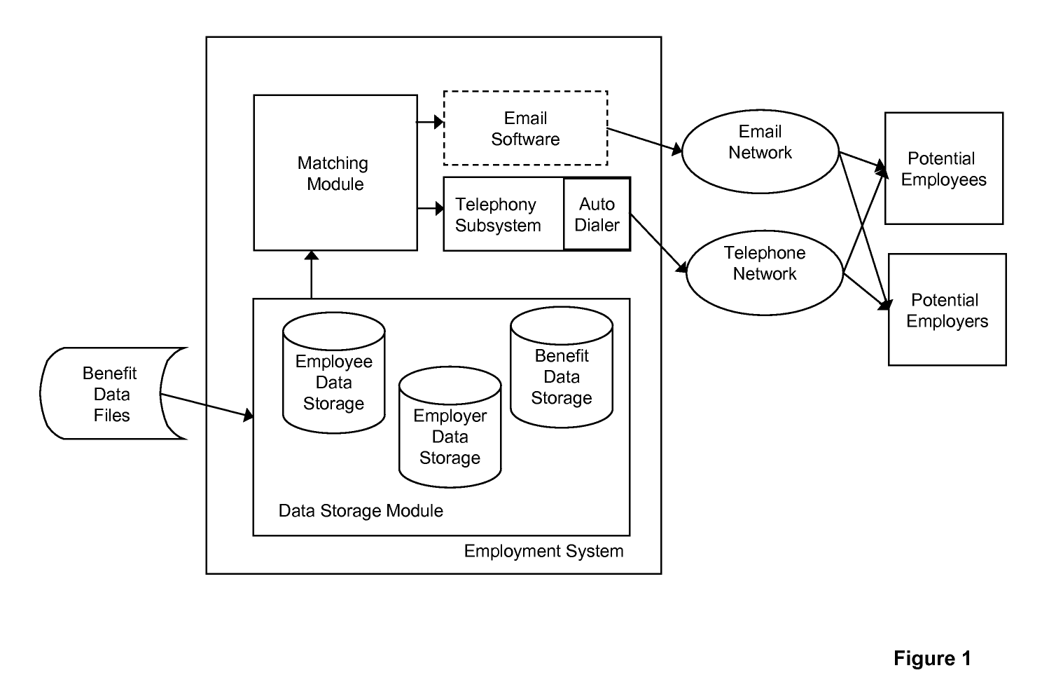

Referring to FIG. 1, the invention provides an employment system that identifies and contacts potential employees and provides information regarding opportunities to return to work. In one embodiment, a computerized database containing information about the potential employees (e.g., names, addresses, phone numbers, benefit status, email addresses, impairment code, and similar information) is constructed from one or more sources of such data (“employee data”). Examples of such sources may include the Social Security Administration, state vocational rehabilitation agencies or insurance companies that collect such data. In addition to data regarding the potential employees, information about potential programs, benefits and other services (“benefit data”) can also be stored in the database and, in some cases, provided to the potential employees. Further, potential employers may also provide data to the system via electronic and/or manual methods (“employer data”). In such cases, an employer may indicate an interest in hiring one or more of the potential employees, certain skills that are needed, and other particulars about the job being offered such as pay, hours, location, etc.

Each database may be stored in separate physical data storage module on one or more servers, as separate logical partitions within a single database, or in a single database. The data storage systems provide data to a matching module that executes application logic to implement the methods described below. Examples of database servers that may be used to implement the data storage modules include the MySQL Database Server by Sun Microsystems, the PostgreSQL Database Server by the PostgreSQL Global Development Group of Berkeley, Calif., and the ORACLE Database Server offered by ORACLE Corp. of Redwood Shores, Calif.

The matching module uses programmed application logic (typically in the form of software commands) to match potential employees with benefits and/or services that may be of interest, as well as employers that have expressed an interest in hiring new employees, contractors or consultants. For example, an employer in a certain geographical location may need to hire new employees. The employer may be unaware, however, that hiring individuals that are currently receiving some form of government benefit (e.g., disability) entitles the employer to receive tax breaks, wage enhancements, or other government-sponsored incentives for hiring such individuals. In the same area, there may be a number of individuals currently on disability that are interested in returning to work, but are unaware of potential opportunities, and also are not aware of the incentives described above. By matching potential employees to potential employers, the system identifies those individuals (based on geography, skill set, etc.) that are likely to satisfy the job requirements outlined by the employer.

The employment system also includes one or more communication applications such as a telephony system and/or email software. Once the matching module identifies potential matches between employers and employees, the system can initiate communications to and/or between the employees and employers. Such communications may be made as one-time calls or emails, or in some cases according to a periodic contact schedule (e.g., quarterly). In one exemplary embodiment, the system includes an auto-dialer that receives telephone numbers from the employee database and automatically dials the telephone numbers in an attempt to provide the potential employees with information about the employment opportunities available in their area. The auto-dialer technology can place simple auto-dialer calls or more sophisticated calls with outbound interactive voice response capabilities. In some cases, the auto-dialer can be programmed to automatically call a specified group of individuals with or without specific disabilities. The message can be customized to the type of government benefits received by that class of beneficiaries. The message delivered by the auto-dialer provides the recipient a user-friendly method of accessing a variety of information, such as information related to Social Security work incentives applicable to them, or tax credits available to their employers, job search advice, and a description of employment assistance services, such as training and technical accommodations. To indicate an interest in receiving more information on a particular topic, the recipient of the call can respond to the message by pressing a prompted number on the phone key pad, speaking a number, or responding according to other methods.

In some embodiments, the information may be distributed via email. For example, potential employees that have provided an email address and other job-related preferences (e.g., location, job type, pay requirements, etc.) may receive emails listing job opportunities matching their preferences. Examples of email servers that can provide such functionality include the SendMail system by SENDMAIL.ORG, and the Windows Exchange Server by MICROSOFT. In other embodiments, the information may be distributed via United States Postal Service and/or other courier services.

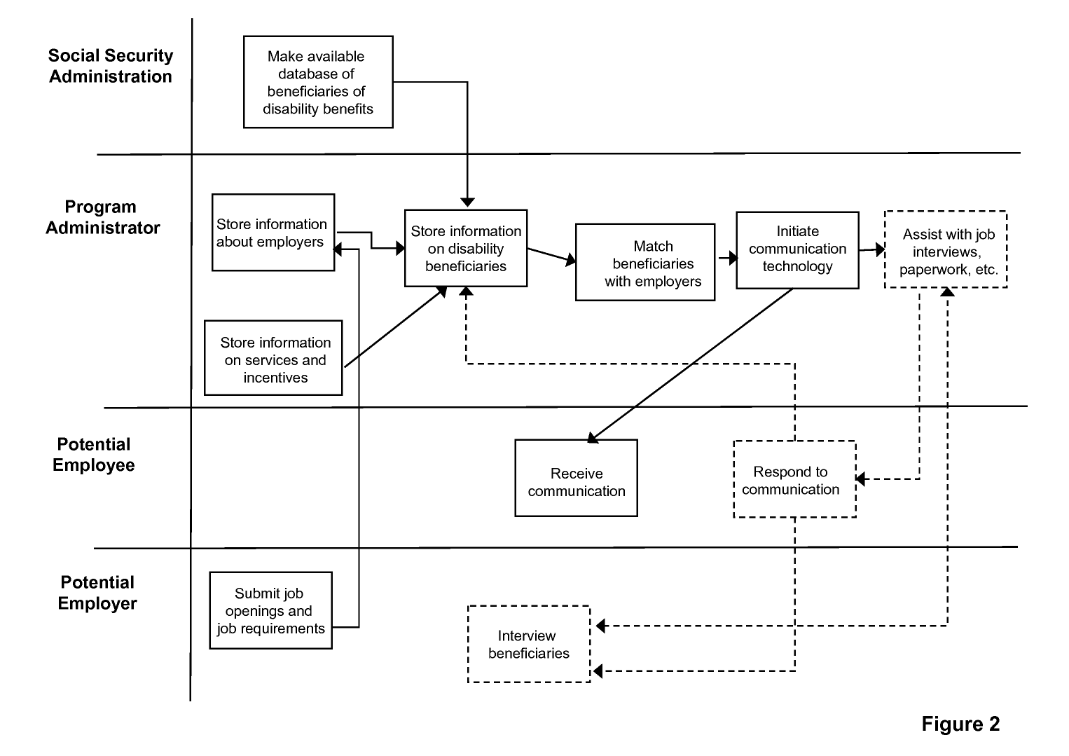

FIG. 2 illustrates one possible implementation of the invention in which potential employees can be matched to potential employers. In one embodiment, a program administrator receives employee data from one or more sources, including, for example, the Social Security Administration, state vocational rehabilitation agencies and/or insurance agencies. The system may also maintain a computerized database of benefit data, which can consist of data previously and/or periodically received from various sources and/or data entered by the program administrator. In some cases, the data is periodically updated to reflect new information regarding the services and incentives available to the employees and employers.

The system may also include a computerized database containing information about potential employers interested in hiring potential employees. Information about the potential employers can be obtained in a variety of ways. For example, a search of on-line help-wanted notices can be performed in a targeted geographic or market area. Employers who have posted such help wanted notices may be contacted via voice calls, fax and/or email and may, in some cases, be offered free recruiting services and tax credit assistance in exchange for a commitment to consider referred employees for their job openings. If the employers agree to such a commitment, information about available employment opportunities can be entered into the employer database. Employers can also be recruited via referrals, direct contacts and media publications and entered into the employer database, and identified as being interested in interviewing potential employees for job openings. In some cases, employers having agreed to be included in the database can be periodically sent email reminders of the offer to provide free recruiting service and tax credit consultation in exchange for hiring referred employees.

Still referring to FIG. 2, the program administrator initiates a matching process to match potential employees from the employee database to employers with current job openings from the employer database using one or more of several matching criteria (e.g., skill set, geographic region, hours, pay, etc.). Once a set of potential matches has been generated, employees are contacted about the potential job opportunities. In some cases, the contact is automatic—i.e., once a match is found an automated message is generated and sent without human interaction or approval. In other instances, the contact may require the program administrator to initiate and/or approve the communication. In one embodiment, the contact is initiated using an auto-dialer, which initiates phone calls to the potential employees. When a potential employee answers the call, an automated message may then be delivered. The message can be general in nature (e.g., there are 24 job openings within a 5 mile radius) or more specific, providing descriptions of job openings and the employers who are currently accepting job applicants. The potential employee may also request additional information about specific jobs, how to apply for specific jobs, and in some cases information about contacting the employer directly. The potential employee may also be identified in the system to receive updates about other job openings, job seeking advice and/or information about employment incentives. Such information may be requested by pressing a corresponding number on a phone key pad, speaking the corresponding number, speaking to a customer service representative, or responding according to other methods. The potential employees may also opt out of the program entirely. The choices the individuals make during the contact process can be recorded in the employee database and used to generate follow-up calls as well as usage and effectiveness statistics.

In some embodiments, the information may be distributed via email. For example, potential employees that have provided an email address and other job-related preferences (e.g., location, job type, pay requirements, etc.) may receive automatically generated emails listing job opportunities matching their preferences. In addition, these potential employees can receive other employment-related information by responding to the email or clicking on hyperlinks to information provided via the Internet and World Wide Web. Choices made by individuals interacting with the contacts can be stored in the employee information database to provide more targeted offerings in the future.

For example, once a potential employee indicates she is thinking about or engaging in job-seeking activities (via her auto-dialer menu choices, for example), she can be targeted for additional auto-dialer offerings (or personal phone calls) customized to her particular needs and interests. For example, if the individual requests information on “Best Ways to Search for Work,” she may be targeted for follow-up calls offering resume preparation assistance, a breakdown of industry employment statistics in her local area and/or advice on how to dress for an interview. In another example, an individual requesting information on the impact that work earnings might have on his government-provided benefits may be provided with information on federal or state medical insurance plans for people with disabilities who work, regulations pertaining to employment and subsidized housing and information on how his various federal, state or private disability cash benefits would be impacted by his earnings.

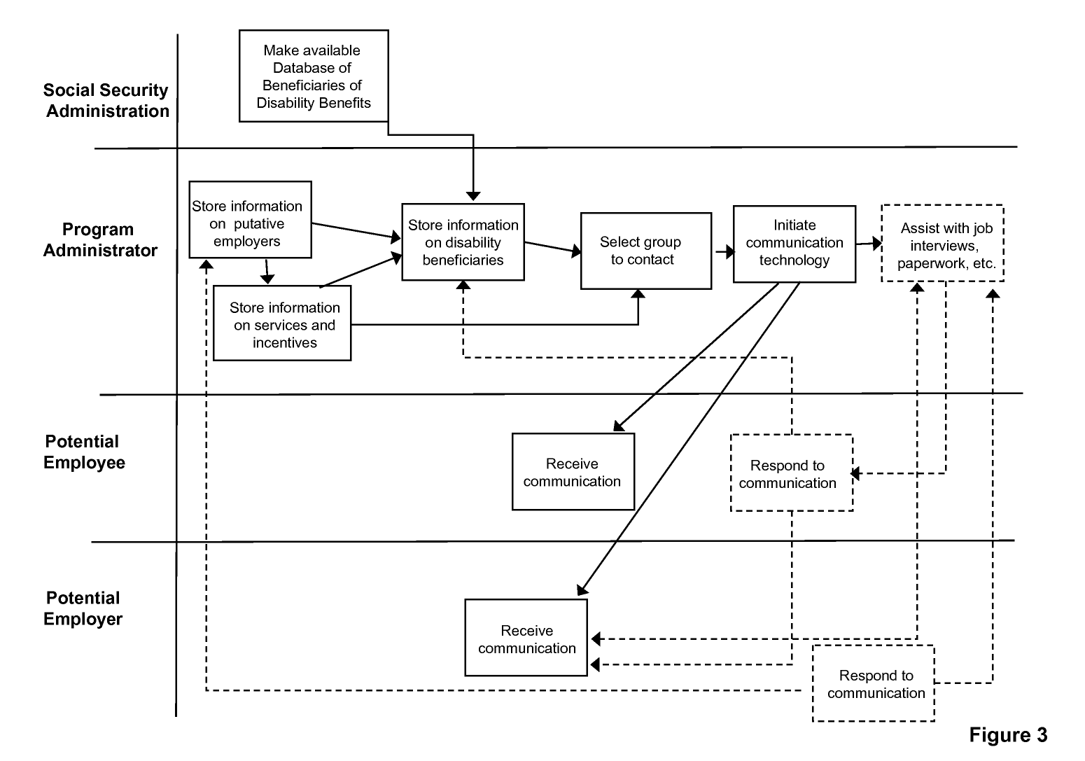

FIG. 3 illustrates another aspect of the invention in which a method for providing potential employees with a menu of available employment and incentive services encourages and promotes job seeking behavior and vocational rehabilitation and facilitates contact with potential employers as well as the potential employees.

In addition to the steps described above with reference to FIG. 2, potential employers, whose information has been saved in the employer database, can be contacted (either automatically or in person by the program administrator, for example) and provided with information about the benefits and incentives associated with hiring referred employees. In some embodiments, a random list of potential employers can be used. The choices that potential employers make can be used to update the employer database to provide more targeted information in the future or used in the matching of potential employees with potential employers according to the methods described above and illustrated in FIG. 2.

One benefit of this invention is that it allows for easy identification of individuals receiving government-provided benefits who are actively interested in employment and providing them with timely information and services targeting their areas of concern. The inexpensive nature of this outreach effort also makes it possible to use the system as a consciousness-raising prompt that can be delivered at pre-determined intervals. Messages delivered over VOIP auto-dialer systems can currently be delivered at about 2 cents per call. Therefore, an auto-dialed recorded message delivered to a beneficiary once a month for a year could cost less than the price of a first class stamp. Many individuals contacted through this method will not be at a point in their lives in which they are thinking about or planning work activities. Some may be too ill or otherwise occupied with life's challenges to pursue employment. Periodic calls that remind individuals that work may be an option for them, however, and that help is just a phone key pad press away, can increase the probability that the offer will catch them at a time when they are ready to act. The low cost of the automated outreach method allows for frequent “pinging” of the beneficiaries reminding them that work is an option. It can drive home the message that answers to their questions and other forms of help are readily available. By pinging quarterly for example, these messages are more likely to land on receptive ears. People's lives change and their receptivity to the thought of exploring employment changes as well.

In addition, this invention allows for the education of employers regarding and benefits and incentives associated with hiring individuals receiving government-provided benefits. Numerous employers are simply unaware of such benefits and this invention provides a cost-effective solution for raising collective consciousness. This invention also provides a mechanism for overcoming employer inertia. For example, employers who are aware of the incentives, but unwilling to take the time to complete the paperwork, can opt to have the program administrator complete the paperwork for them.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of promoting and supporting employment seeking and employment retention behaviors among recipients of government-provided benefits, the method comprising:
receiving a list of potential employees, the potential employees being identified as receivers of government-provided benefits;
automatically contacting one or more of the potential employees based upon a selection criteria;
providing contacted potential employees with a menu of employment and incentive services available to the potential employees;
receiving a request for information regarding the employment and incentive services from at least one contacted potential employee; and
delivering the requested information to that potential employee.

2. The method of claim 1 wherein the potential employees are automatically contacted at least three times per year.

3. The method of claim 1 wherein the potential employees are contacted via telephone using an auto-dialer.

4. The method of claim 1 wherein the government-provided benefits comprise disability benefits.

5. The method of claim 1 wherein the list of potential employees is received from the Social Security Administration.

6. The method of claim 1 further comprising storing a representation of the request for information in an electronic database.

7. The method of claim 1 further comprising providing access to a counselor, thus facilitating delivery of the requested information via personal interaction.

8. The method of claim 1 further comprising providing an offer of services to be delivered via distance training methods.

9. The method of claim 1 further comprising determining when to schedule subsequent contacts with one or more of the potential employees based on a contact algorithm.

10. The method of claim 1 wherein contacting the one or more of the potential employees comprises employing outbound interactive voice response technology in which more than one menu of choices are presented to the one or more of the potential employees and the order of the choices is determined by the previous choices made by the one or more of the potential employees.

11. The method of claim 1 further comprising initiating subsequent automatic contacts comprising content determined by a contacted potential employee's response to a first automated contact.

12. The method of claim 1 further comprising selecting content of auto-dialer calls in accordance with a contacted potential employee's response to a screening instrument.

13. The method of claim 1 further including mailing a letter to the at least one potential employee informing of an auto-dialer campaign.

14. The method of claim 3 wherein the auto-dialer utilizes Voice Over Internet Protocol (VOIP) technology.

15. The method of claim 1 wherein the requested information is delivered to the potential employee electronically.

16. A method of matching potential employees to potential employers, the method comprising:
receiving a list of potential employees, the potential employees being identified as receivers of government disability benefits;
receiving a list of potential employers;
matching one or more of the potential employees to one or more of the potential employers;
automatically contacting the one or more potential employees; and
providing information to the one or more potential employees regarding the one or more potential employers.

17. The method of claim 16 wherein the matching step comprises identifying potential employees within a predetermined geographical area.

18. The method of claim 16 wherein the matching step comprises identifying potential employees having one or more predetermined skills.

19. The method of claim 16 wherein the potential employees are automatically contacted via an auto-dialer.

20. The method of claim 16 wherein the potential employees are automatically contacted via email.

21. The method of claim 16 further comprising receiving an indication of interest from at lease one of the potential employees with regard to at least one of the potential employers.

22. The method of claim 16 further comprising facilitating communication between at least one of the potential employees and at least one of the potential employers.

23. The method of claim 16 further comprising providing information about hiring incentives concerning the one or more of the potential employees to at least one of the potential employers.

24. The method of claim 16 further comprising assisting at least one of the potential employers with receipt of incentives for hiring at least one of the potential employees.

25. The method of claim 16 wherein the potential employee is contacted on a frequency schedule of at least three times per year.

26. A system for promoting and supporting employment seeking and employment retention behaviors among recipients of government-provided benefits, the system comprising:
a storage device for storing:
a list of potential employees receiving government-provided benefits;
a list of services and incentives potentially available to the potential employees;
and a list of potential employers;
a matching module configured to compile a listing of one or more of the potential benefits and one or more of the potential employers for at least one of the potential employees based on characteristics of the potential employee and the potential employers; and
a telephony subsystem configured to:
automatically contact the potential employee via telephone; and
present at least a portion of the compiled listing to the potential employee.
